(19) United States
(12) Patent Application Publication
(10) Pub. No.: US 2026/0238023 A1
(43) Pub. Date: Aug. 13, 2026

(54) PORTABLE ENERGY STORAGE DEVICE CAPABLE OF SIMULTANEOUS MULTI-PORT CHARGING AND CHARGING POWER ALLOCATION METHOD

(71) Applicant: NINGBO SOYAR TECHNOLOGY INNOVATION CO., LTD., Ningbo (CN)

(72) Inventor: Tao HUANG, Ningbo (CN)

(73) Assignee: NINGBO SOYAR TECHNOLOGY INNOVATION CO., LTD., Ningbo (CN)

(21) Appl. No.: 19/316,555

(22) Filed: Sep. 2, 2025

(30) Foreign Application Priority Data
Sep. 4, 2024 (CN) 2024112367640

(51) Int. Cl. H02J 7/52; H02J 7/34; H02J 7/60; H02J 7/65; H02J 7/70; H02J 7/90; H02J 7/94; H02J 7/96

(52) U.S. Cl. CPC H02J 7/52; H02J 7/34; H02J 7/65; H02J 7/663; H02J 7/751; H02J 7/933; H02J 7/94; H02J 7/96

(57) ABSTRACT

A portable energy storage device capable of simultaneous multi-port charging and a charging power allocation method, wherein at least two power input ports are provided, which can be used individually or simultaneously. When multiple ports are used simultaneously, through an ingenious power allocation logic design, each power input channel is ensured to operate in a balanced manner. This avoids the situation where one channel operates at high power while other channels operate at very low power or are idle, causing heat to concentrate in one location. Thereby, the safety of the portable energy storage device during charging is enhanced, and its service life is prolonged. Furthermore, this design also enables the multiple external charging sources that are connected and supplying power simultaneously to share the power load more evenly, thereby preventing these power sources from operating under full load conditions.

### TECHNICAL FIELD

The present invention relates to the technical field of mobile power sources, specifically to a portable energy storage device capable of simultaneous multi-port charging, and a charging power allocation method applied to the portable energy storage device.

### BACKGROUND ART

With the popularization of mobile devices and the increase in people's outdoor activities, the demand for portable energy storage devices is increasing. Whether for outdoor camping, emergency power needs, or daily charging of mobile devices, portable energy storage devices that provide reliable power have become indispensable tools. Portable energy storage devices have a wide range of application scenarios, and users' requirements for their functional diversity and convenience are constantly increasing.

However, existing portable energy storage devices generally suffer from the problem of slow self-charging speed, mainly because such devices are usually equipped with only one power input port, resulting in low efficiency when users charge the energy storage device itself. This design limitation makes it difficult for users to quickly replenish power for the energy storage device in time-critical situations, which can easily affect travel arrangements or travel experiences.

Based on this technical problem, technicians have proposed the idea of setting up multiple power input ports to achieve fast charging of portable energy storage devices. However, it has been found in practical application that when multiple power sources simultaneously charge the mobile energy storage device, due to the lack of a reasonable power allocation mechanism, results such as low charging efficiency, overload, or even damage to the energy storage device occur.

### SUMMARY OF THE INVENTION

To address the deficiencies in the prior art, the purpose of the present invention is to provide a portable energy storage device capable of simultaneous multi-port charging and a corresponding charging power allocation method. Through an ingenious power allocation logic design, each power input channel is ensured to operate in a balanced manner. This avoids the situation where one channel operates at high power while other channels operate at very low power or are idle, causing heat to concentrate in one location. Thereby, the safety of the portable energy storage device during charging is enhanced, and its service life is prolonged. Furthermore, this design also enables the multiple external charging sources that are connected and supplying power simultaneously to share the power load more evenly, thereby preventing these power sources from operating under full load conditions, thus greatly extending the service life of the external charging sources.

To achieve the above inventive purpose, the present invention adopts the following technical solutions:

According to a first aspect of the present invention, there is provided a portable energy storage device capable of simultaneous multi-port charging, wherein
the device comprises a power configuration unit and two power input ports, the power configuration unit is configured to allocate charging power for power input ports connected to external charging sources; defining the maximum allowable input power of the energy storage device as Pmax_in;
when the number of power input ports connected to external charging sources is two, then:
a) when the sum of the maximum allowable charging power of the two power input ports≤Pmax_in, the power configuration unit configures both power input ports to operate at their respective maximum allowable charging power;
b) when the sum of the maximum allowable charging power of the two power input ports>Pmax_in, the power configuration unit configures the sum of the operating power of the two power input ports to be Pmax_in, and allocates power according to the following rules:
I) if the maximum allowable charging power of both power input ports is greater than Pmax_in/2, the power configuration unit configures both power input ports to operate at Pmax_in/2;
II) if the maximum allowable charging power of one of the power input ports ≤Pmax_in/2, the power configuration unit configures this power input port to operate at its maximum allowable charging power, and configures the other power input port to operate at the remaining power, the remaining power=(Pmax_in−the operating power of the power input port operating at its maximum allowable charging power).

According to a second aspect of the present invention, there is provided a portable energy storage device capable of simultaneous multi-port charging, wherein
the device comprises a power configuration unit and at least three power input ports, the power configuration unit is configured to allocate the charging power for the power input ports that are connected to external charging sources, defining the maximum allowable input power of the energy storage device as Pmax_in;
when the number of power input ports connected to external charging sources is ≥2, defining this number as N, then:
if the sum of the maximum allowable charging powers of these connected ports>Pmax_in, the power configuration unit configures these ports to operate with a total power sum of Pmax_in, and allocates power according to the following rules:
a) when the maximum allowable charging power of each of these connected ports is >Pmax_in/N, the power configuration unit configures all these ports to operate at Pmax_in/N;
b) when among these connected ports, some ports have a maximum allowable charging power≤Pmax_in/N, then for those specific ports, the power configuration unit performs the first power configuration, setting them to operate at their maximum allowable charging power, assuming the total power occupied by these ports configured in the first step is B₁, the remaining power available for configuration is P₁=Pmax_in−B₁, the number of remaining connected ports yet to have power allocated is M₁=N−(number of ports configured at max power in the first step), then for the remaining M₁ ports:
I) if their maximum allowable charging powers are all>P₁/M₁, the power configuration unit sets all remaining M₁ ports to operate at P₁/M₁;
II) if there are still some ports among the remaining MI ports with maximum allowable charging power≤P₁/M₁, the power configuration unit configures power according to the following rule, defining within this rule that after the k-th power configuration where k is a positive integer and k≥1, the total power occupied by ports configured at their maximum allowable charging power in the k-th step is Bₖ, the remaining power available for configuration is Pₖ, and the number of remaining connected ports yet to have power allocated is Mₖ:
among the remaining Mₖ ports, for ports whose maximum allowable charging power≤Pₖ/Mₖ, the power configuration unit performs the (k+1)-th power configuration, setting those ports to operate at their maximum allowable charging power, assuming the total power occupied by these ports configured in the (k+1)-th step is Bₖ₊₁, the remaining power available for configuration is Pₖ₊₁=P_max_in−B1− . . . −Bₖ₊₁, the number of remaining connected ports yet to have power allocated is Mₖ₊₁=Mₖ−(number of ports configured at max power in the (k+1)-th step); within this rule, when after the (k+1)-th power configuration, the maximum allowable charging powers of all the remaining Mₖ₊₁ ports are >Pₖ₊₁/Mₖ₊₁, this rule terminates, and the power configuration unit sets all remaining Mₖ₊₁ ports to operate at Pₖ₊₁/Mₖ₊₁.

As a preferred embodiment of the second aspect of the present invention, when the number of power input ports connected to external charging sources≥2, if the sum of the maximum allowable charging power of these connected ports≤Pmax_in, the power configuration unit configures these connected ports to operate at their respective maximum allowable charging power.

As a preferred embodiment of the first or second aspect of the present invention, each power input port is predefined with a maximum charging power, and the maximum allowable charging power of a port is the smaller of the two values:
a) the port's predefined maximum charging power, and
b) the charging power that can be provided by the external charging source after it is connected to the port.

As a preferred embodiment of the first or second aspect of the present invention, when the number of power input ports connected to an external charging source is one, then:
a) if the maximum allowable charging power of this power input port≤Pmax_in, the power configuration unit configures this power input port to operate at its maximum allowable charging power;
b) if the maximum allowable charging power of this power input port>Pmax_in, the power configuration unit configures this power input port to operate at Pmax_in.

As a preferred embodiment of the first or second aspect of the present invention, some or all of power input ports are bidirectional ports that can be used for both charging and discharging.

As a preferred embodiment of the first or second aspect of the present invention, the interior of the portable energy storage device is provided with a main control board, and one or more independent circuit boards connected to the main control board, the power input ports are arranged on the circuit boards, and the power configuration unit is arranged on the main control board.

As a preferred embodiment of the first or second aspect of the present invention, the power configuration unit calculates the real-time power demand of each power input port by reading preset parameters of the power input ports and accordingly configures the charging power of each power input port, the preset parameters including current and voltage.

As a preferred embodiment of the first or second aspect of the present invention, both the printed circuit board and main control board are provided with protection circuits, the protection circuits including but not limited to any one or more of: overcurrent protection circuit, overvoltage protection circuit, overtemperature protection circuit, and short-circuit protection circuit (SCP);
wherein upon detection of abnormal conditions, the protection circuits respond by cutting off power to relevant circuits as necessary.

According to a third aspect of the present invention, there is provided a method for allocating charging power in a portable energy storage device, wherein the method is applied to the portable energy storage device capable of simultaneous multi-port charging according to the first aspect of the present invention, and comprises:
when the number of power input ports connected to external charging sources is two, then:
a) when the sum of the maximum allowable charging power of the two power input ports≤Pmax_in, the power configuration unit configures both power input ports to operate at their respective maximum allowable charging power;
b) when the sum of the maximum allowable charging power of the two power input ports>Pmax_in, the power configuration unit configures the sum of the operating power of the two power input ports to be Pmax_in, and allocates power according to the following rules:
I) if the maximum allowable charging power of both power input ports is greater than Pmax_in/2, the power configuration unit configures both power input ports to operate at Pmax_in/2;
II) if the maximum allowable charging power of one of the power input ports ≤Pmax_in/2, the power configuration unit configures this power input port to operate at its maximum allowable charging power, and configures the other power input port to operate at the remaining power, the remaining power=(Pmax_in−the operating power of the power input port operating at its maximum allowable charging power).

According to a fourth aspect of the present invention, there is provided a method for allocating charging power in a portable energy storage device, wherein the method is applied to the portable energy storage device capable of simultaneous multi-port charging according to the second aspect of the present invention, and comprises:
when the number of power input ports connected to external charging sources is ≥2, defining this number as N, then:
if the sum of the maximum allowable charging powers of these connected ports>Pmax_in, the power configuration unit configures these ports to operate with a total power sum of Pmax_in, and allocates power according to the following rules:
a) when the maximum allowable charging power of each of these connected ports is >Pmax_in/N, the power configuration unit configures all these ports to operate at Pmax_in/N;
b) when among these connected ports, some ports have a maximum allowable charging power≤Pmax_in/N, then for those specific ports, the power configuration unit performs the first power configuration, setting them to operate at their maximum allowable charging power, assuming the total power occupied by these ports configured in the first step is B₁, the remaining power available for configuration is P₁=Pmax_in−B₁, the number of remaining connected ports yet to have power allocated is M₁=N−(number of ports configured at max power in the first step), then for the remaining M₁ ports:
I) if their maximum allowable charging powers are all>P₁/M₁, the power configuration unit sets all remaining M₁ ports to operate at P₁/M₁;
II) if there are still some ports among the remaining M₁ ports with maximum allowable charging power≤P₁/M₁, the power configuration unit configures power according to the following rule, defining within this rule that after the k-th power configuration where k is a positive integer and k≥1, the total power occupied by ports configured at their maximum allowable charging power in the k-th step is Bₖ, the remaining power available for configuration is Pₖ, and the number of remaining connected ports yet to have power allocated is Mₖ:
among the remaining Mₖ ports, for ports whose maximum allowable charging power≤Pₖ/Mₖ, the power configuration unit performs the (k+1)-th power configuration, setting those ports to operate at their maximum allowable charging power, assuming the total power occupied by these ports configured in the (k+1)-th step is Bₖ₊₁, the remaining power available for configuration is Pₖ₊₁=P_max_in−B1− . . . −Bₖ₊₁, the number of remaining connected ports yet to have power allocated is Mₖ₊₁=Mₖ−(number of ports configured at max power in the (k+1)-th step); within this rule, when after the (k+1)-th power configuration, the maximum allowable charging powers of all the remaining Mₖ₊₁ ports are >Pₖ₊₁/Mₖ₊₁, this rule terminates, and the power configuration unit sets all remaining Mₖ₊₁ ports to operate at Pₖ₊₁/Mₖ₊₁.

Compared with the prior art, the present invention has the following beneficial effects:
1. The portable energy storage device capable of simultaneous multi-port charging and the charging power allocation method provided by the present invention, through the design of two or more power input ports, can meet the demand for multiple external charging sources to simultaneously charge the portable energy storage device, greatly speeding up charging efficiency. Furthermore, the present invention imposes no restrictions on the types of power input ports, meaning that in practical applications, the power input ports can be various types of input ports, and the types of the power input ports can be the same or different from each other, thereby improving flexibility in practical application.
2. The portable energy storage device capable of simultaneous multi-port charging and the charging power allocation method provided by the present invention, when multiple power input ports are used simultaneously, through an ingenious power allocation logic design, ensure that each power input channel can work in a balanced manner. This avoids the situation where one channel operates at high power while other channels operate at very low power or are idle, causing heat to concentrate in one location. Thereby, the safety of the portable energy storage device during charging is enhanced, and its service life is prolonged. Furthermore, this design also enables the multiple external charging sources used to power the portable energy storage device to share the power more evenly, thereby preventing the external charging sources from operating under full load conditions, thus greatly extending the service life of the external charging sources.
3. The portable energy storage device capable of simultaneous multi-port charging and the charging power allocation method provided by the present invention, through further design, allow the power input ports to be used individually or simultaneously. When used individually, by comparing the relationship between the device's maximum allowable input power and the port's maximum allowable charging power, the device can achieve maximum charging power input while ensuring safety.

### BRIEF DESCRIPTION OF THE DRAWINGS

By reading the detailed description of non-limiting embodiments with reference to the following drawings, other features, purposes and advantages of the present invention will become more apparent:

FIG. 1 is a schematic structural diagram of the portable energy storage device according to the first embodiment of the present invention, wherein the number of power input ports is two;

FIG. 2 is a schematic structural diagram of the portable energy storage device according to the second embodiment of the present invention, wherein the number of power input ports is three;

FIG. 3 is a schematic structural diagram of the portable energy storage device according to the second embodiment of the present invention, wherein the number of power input ports is four.

The drawings show:
101—First power input port;
102—Second power input port;
103—Third power input port;
104—Fourth power input port;
201—Power configuration unit.

### DETAILED DESCRIPTION

To make the purposes, technical solutions, and advantages of the embodiments of the present application clearer, the technical solutions in the embodiments of the present application will be described clearly and completely below in conjunction with the drawings in the embodiments of the present application. Obviously, the described embodiments are part of the embodiments of the present application, not all of them. Generally, the components of the embodiments of the present application described and illustrated in the accompanying drawings herein can be arranged and designed in various different configurations.

Therefore, the following detailed description of the embodiments of the present application provided in the accompanying drawings is not intended to limit the scope of the claimed present application, but merely represents selected embodiments of the present application. Based on the embodiments in the present application, all other embodiments obtained by those of ordinary skill in the art without creative efforts shall fall within the protection scope of the present application.

It should be noted that similar reference numerals and letters indicate similar items in the following drawings. Therefore, once an item is defined in one drawing, it does not need to be further defined and explained in subsequent drawings. In addition, all directional indications (such as up, down, left, right, front, back, bottom . . . ) in the present application are only used to explain the relative positional relationships, movement conditions, etc., between components in a specific posture (as shown in the drawings). If this specific posture changes, the directional indication will change accordingly. Furthermore, in the application, descriptions involving “first,” “second,” etc., are for descriptive purposes only and are not to be construed as indicating or implying relative importance or implicitly specifying the quantity of the indicated technical features.

Furthermore, in the present invention, the use of terms such as “these,” “sum,” “each,” etc., does not necessarily require the number of power input ports to be two or more; it also includes the case where the number of power input ports is one. When the number of power input ports is one, for example, “these power input ports” refers to “this one power input port,” and “the sum of the maximum allowable charging power of the power input ports” refers to “the maximum allowable charging power of the power input port.” Further, in the present invention, when two values A and B are equal, either one is considered the smaller value. Therefore, the so-called “taking the smaller value between A and B as the maximum allowable charging power” in the present invention includes the case where A and B are equal and either A or B can be taken as the smaller value.

### Embodiment 1

This embodiment provides a portable energy storage device capable of simultaneous multi-port charging. Structurally, the entire energy storage device is made of lightweight, high-strength shell material. Its interior is provided with one or more independent circuit boards. The circuit boards are provided with power input ports and charging input ports, and the circuit boards are connected to the main control board via wires. An intelligent control chip is embedded on the main control board. The chip includes a power configuration unit 201 for executing the power allocation algorithm. The power configuration unit 201 calculates the real-time power demand of each port by reading parameters such as current and voltage of each port and accordingly adjusts the charging and discharging power of each port. Additionally, protection circuits such as over-current protection, over-voltage protection, over-temperature protection, and short-circuit protection are provided on both the circuit board and the main control board. When an abnormal condition is detected, these protection circuits respond quickly and cut off the power supply to the relevant circuit. Since the core of this embodiment lies in the power allocation logic when the energy storage device is in charging-only mode, it is specifically elaborated as follows:

As shown in FIG. 1, the portable energy storage device capable of simultaneous multi-port charging provided in this embodiment includes two power input ports and a power configuration unit 201, wherein the power configuration unit 201 is configured to allocate charging power for power input ports connected to external charging sources.

For differentiation and description convenience, when only one power input port is inserted with an external charging source, it is defined as the first power input port 101. When both power input ports are inserted with external charging sources, they are defined as the first power input port 101 and the second power input port 102, respectively.

The first power input port 101 and the second power input port 102 are both preset with maximum charging powers. The preset maximum charging power of the first power input port is defined as a₁, and the maximum charging power that can be provided by an external charging source after being connected to the first power input port is defined as b₁. The smaller value between a₁ and b₁ is taken as the maximum allowable charging power of the first power input port 101. Similarly, the preset maximum charging power of the second power input port is defined as a₂, and the maximum charging power that can be provided by an external charging source after being connected to the second power input port is defined as b₂. The smaller value between a₂ and b₂ is taken as the maximum allowable charging power of the second power input port 102.

Furthermore, define the maximum allowable input power of the portable energy storage device provided in this embodiment as Pmax_in, and define the maximum allowable charging power of the first power input port 101 and the second power input port 102 as Pmax_c1_in and Pmax_c2_in, respectively. When charging the portable energy storage device provided in this embodiment with external charging sources:
1. When the sum of the maximum allowable charging power of the power input ports connected to external charging sources≤Pmax_in, the power configuration unit 201 configures these power input ports to operate at their respective maximum allowable charging power. This includes two situations:
(1) When only the first power input port 101 is inserted with an external charging sources, if Pmax_c1_in≤Pmax_in, the power configuration unit 201 configures the first power input port 101 to operate at Pmax_c1_in. For example, when the maximum allowable input power Pmax_in of the portable energy storage device is 120 W, and the maximum allowable charging power Pmax_c1_in of the first power input port 101 connected to an external charging source is 60 W, since Pmax_c1_in<Pmax_in, the power configuration unit 201 configures the first power input port 101 to operate at Pmax_c1_in, i.e., 60 W.
(2) When both the first power input port 101 and the second power input port 102 are connected to external charging sources, if Pmax_c1_in+Pmax_c2_in≤Pmax_in, the power configuration unit 201 configures the first power input port 101 to operate at Pmax_c1_in and the second power input port 102 to operate at Pmax_c2_in. For example, when the maximum allowable input power Pmax_in of the portable energy storage device is 120 W, the maximum allowable charging power Pmax_c1_in of the first power input port 101 is 50 W, and the maximum allowable charging power Pmax_c2_in of the second power input port 102 is 60 W, since Pmax_c1_in+Pmax_c2_in is 110 W, which is less than Pmax_in (120 W), the power configuration unit 201 configures the first power input port 101 to operate at Pmax_c1_in (50 W) and the second power input port 102 to operate at Pmax_c2_in (60 W).

2. When the sum of the maximum allowable charging power of the power input ports connected to external charging sources>Pmax_in, the power configuration unit 201 configures those power input ports to have a sum of operating power equal to Pmax_in, and:
(1) If the number of power input ports connected to external charging sources is 1, the power configuration unit 201 configures that power input port to operate at Pmax_in. For example, when the maximum allowable input power Pmax_in of the portable energy storage device is 120 W, and the maximum allowable charging power Pmax_c1_in of the first power input port 101 connected to a charging source is 130 W, since Pmax_c1_in>Pmax_in, the power configuration unit 201 configures the first power input port 101 to operate at Pmax_in, i.e., 120 W.

(2) If the number of power input ports connected to external charging sources is 2:

\textcircled{1} When the maximum allowable charging power of both power input ports is greater than Pmax_in/2, the power configuration unit 201 configures both power input ports to operate at Pmax_in/2. For example, when the maximum allowable input power Pmax_in of the portable energy storage device is 120 W, the maximum allowable charging power Pmax_c1_in of the first power input port 101 is 70 W, and the maximum allowable charging power Pmax_c2_in of the second power input port 102 is 80 W, since Pmax_c1_in+Pmax_c2_in is 150 W, which is greater than Pmax_in (120 W), and Pmax_c1_in and Pmax_c2_in are both>½ of Pmax_in (i.e., 60 W), the power configuration unit 201 configures both the first power input port 101 and the second power input port 102 to operate at 60 W.

\textcircled{2} When the maximum allowable charging power of one of the power input ports <Pmax_in/2, the power configuration unit 201 configures this power input port to operate at its maximum allowable charging power, and configures the other power input port to operate at the remaining power, the remaining power=(Pmax_in−the operating power of the power input port operating at its maximum allowable charging power). For example, when the maximum allowable input power Pmax_in of the portable energy storage device is 120 W, the maximum allowable charging power Pmax_c1_in of the first power input port 101 is 50 W, and the maximum allowable charging power Pmax_c2_in of the second power input port 102 is 80 W, since Pmax_c1_in+Pmax_c2_in is 130 W, which is greater than Pmax_in (120 W), and Pmax_c1_in is less than ½ of Pmax_in (i.e., 60 W), the power configuration unit 201 configures the first power input port 101 to operate at 50 W, and configures the second power input port 102 to operate at (Pmax_in−Pmax_c1_in), i.e., 70W.

The portable energy storage device capable of simultaneous multi-port charging provided in this embodiment has the following advantages: First, through the design of two power input ports, it can meet the demand for two external charging sources to simultaneously charge the portable energy storage device, greatly speeding up charging efficiency; Second, the implementation of this technical solution and its technical effects impose no restrictions on the types of power input ports, meaning that in practical applications, the power input ports can be various types of input ports, and the types of the two power input ports can be the same or different from each other, thereby improving flexibility in practical application. For example, both power input ports can be bidirectional ports that can be used for both charging and discharging; Third, the two power input ports can be used individually or simultaneously. When used individually, by comparing the relationship between the energy storage device's maximum allowable input power and the port's maximum allowable charging power, the energy storage device can achieve maximum charging power input while ensuring safety; When both power input ports are used simultaneously, through the aforementioned power allocation logic, each power input channel is ensured to work in a balanced manner. This avoids the situation where one channel operates at high power while other channels operate at very low power or are idle, causing heat to concentrate in one location. Thereby, the safety of the portable energy storage device during charging is enhanced, and its service life is prolonged. Furthermore, this design also enables the two external charging sources to share the power more evenly, thereby preventing the external charging sources from operating under full load conditions, thus greatly extending the service life of the external charging sources.

### Embodiment 2

This embodiment provides a portable energy storage device capable of simultaneous multi-port charging. Its structure is substantially the same as that of the portable energy storage device provided in Embodiment 1. The main difference is that the portable energy storage device provided in Embodiment 1 includes only two power input ports, while the portable energy storage device provided in this embodiment includes at least three power input ports. Specifically:

The portable energy storage device capable of simultaneous multi-port charging provided in this embodiment includes at least three power input ports and a power configuration unit 201, wherein the power configuration unit 201 is configured to allocate charging power for power input ports connected to external charging sources.

Each power input port is preset with a maximum charging power. Define the preset maximum charging power of a power input port as ai, and define the maximum charging power that the external charging source can provide after being connected to that power input port as bi. The smaller value between ai and bi is taken as the maximum allowable charging power of that power input port. Define the maximum allowable input power of the portable energy storage device provided in this embodiment as Pmax_in. When charging the portable energy storage device provided in this embodiment:
1. When the sum of the maximum allowable charging power of the power input ports connected to external charging sources ≤Pmax_in, the power configuration unit 201 configures those power input ports to operate at their respective maximum allowable charging power.
2. When the sum of the maximum allowable charging power of the power input ports connected to external charging sources>Pmax_in, the power configuration unit 201 configures those power input ports to have a sum of operating power equal to Pmax_in, and:
(1) If the number of power input ports connected to external charging sources is 1, the power configuration unit 201 configures that power input port to operate at Pmax_in;
(2) If the number of power input ports connected to external charging sources is N, where N is a positive integer and N≥2:
\textcircled{1} when the maximum allowable charging power of each of these connected ports is >Pmax_in/N, the power configuration unit configures all these ports to operate at Pmax_in/N;
\textcircled{2} when among these connected ports, some ports have a maximum allowable charging power≤Pmax_in/N, then for those specific ports, the power configuration unit performs the first power configuration, setting them to operate at their maximum allowable charging power, assuming the total power occupied by these ports configured in the first step is B₁, the remaining power available for configuration is P₁=Pmax_in−B₁, the number of remaining connected ports yet to have power allocated is M₁=N−(number of ports configured at max power in the first step), then for the remaining M₁ ports:
a. If their maximum allowable charging powers are all>P₁/M₁, the power configuration unit sets all remaining M₁ ports to operate at P₁/M₁;
b. If there are still some ports among the remaining M₁ ports with maximum allowable charging power≤P₁/M₁, the power configuration unit configures power according to the following rule, defining within this rule that after the k-th power configuration where k is a positive integer and k≥1, the total power occupied by ports configured at their maximum allowable charging power in the k-th step is Bₖ, the remaining power available for configuration is Pₖ, and the number of remaining connected ports yet to have power allocated is Mₖ:

Among the remaining Mₖ ports, for ports whose maximum allowable charging power≤Pₖ/Mₖ, the power configuration unit performs the (k+1)-th power configuration, setting those ports to operate at their maximum allowable charging power, assuming the total power occupied by these ports configured in the (k+1)-th step is Bₖ₊₁, the remaining power available for configuration is Pₖ₊₁=P_max_in−B1− . . . −Bₖ₊₁, the number of remaining connected ports yet to have power allocated is Mₖ₊₁=Mₖ−(number of ports configured at max power in the (k+1)-th step); within this rule, when after the (k+1)-th power configuration, the maximum allowable charging powers of all the remaining Mₖ₊₁ ports are >Pₖ₊₁/Mₖ₊₁, this rule terminates, and the power configuration unit sets all remaining Mₖ₊₁ ports to operate at Pₖ₊₁/Mₖ₊₁.

The following strengthens the understanding of the technical solution provided in this embodiment by specifying the specific number of power input ports.

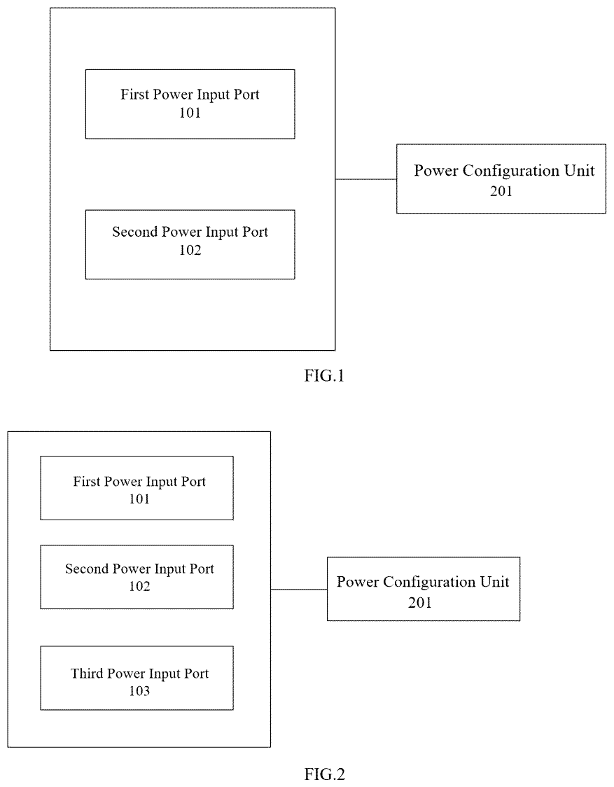

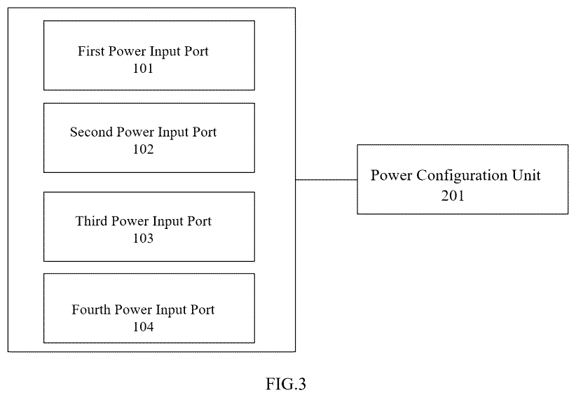

I. When the number of power input ports is three, as shown in FIG. 2:

For differentiation and description convenience, when only one power input port is connected to an external charging source, it is defined as the first power input port 101; when two power input ports are connected to external charging sources, they are defined as the first power input port 101 and the second power input port 102; when all three power input ports are connected with external charging sources, they are defined as the first power input port 101, the second power input port 102, and the third power input port 103. Define the maximum allowable charging power of the first power input port 101, the second power input port 102, and the third power input port 103 as Pmax_c1_in, Pmax_c2_in, and Pmax_c3_in, respectively. When charging the portable energy storage device provided in this embodiment:
1. When the sum of the maximum allowable charging powers of the power input ports connected to external charging sources≤Pmax_in, the power configuration unit 201 configures those power input ports to operate at their respective maximum allowable charging powers. This includes three situations:
(1) When only the first power input port 101 is connected to an external charging source, if Pmax_c1_in≤Pmax_in, then the power configuration unit 201 configures the first power input port 101 to operate at Pmax_c1_in. For example, when the maximum allowable input power Pmax_in of the portable energy storage device is 120 W, and the maximum allowable charging power Pmax_c1_in of the first power input port 101 connected to an external charging source is 60 W, because Pmax_c1_in<Pmax_in, the power configuration unit 201 configures the first power input port 101 to operate at Pmax_c1_in, i.e., 60 W.
(2) When the first power input port 101 and the second power input port 102 are connected to external charging sources, if Pmax_c1_in+Pmax_c2_in≤Pmax_in, then the power configuration unit 201 configures the first power input port 101 to operate at Pmax_c1_in and the second power input port 102 to operate at Pmax_c2_in. For example, when the maximum allowable input power Pmax_in of the portable energy storage device is 120 W, the maximum allowable charging power Pmax_c1_in of the first power input port 101 is 50 W, and the maximum allowable charging power Pmax_c2_in of the second power input port 102 is 60 W, because Pmax_c1_in+Pmax_c2_in is 110 W, which is less than Pmax_in (i.e., 120 W), the power configuration unit 201 configures the first power input port 101 to operate at Pmax_c1_in (i.e., 50 W) and the second power input port 102 to operate at Pmax_c2_in (i.e., 60W).
(3) When the first power input port 101, the second power input port 102, and the third power input port 103 are all connected to external charging sources, if Pmax_c1_in +Pmax_c2_in+Pmax_c3_in≤Pmax_in, then the power configuration unit 201 configures the first power input port 101 to operate at Pmax_c1_in, the second power input port 102 to operate at Pmax_c2_in, and the third power input port 103 to operate at Pmax_c3_in. For example, when the maximum allowable input power Pmax_in of the portable energy storage device is 120 W, the maximum allowable charging power Pmax_c1_in of the first power input port 101 is 30 W, the maximum allowable charging power Pmax_c2_in of the second power input port 102 is 40 W, and the maximum allowable charging power Pmax_c3_in of the third power input port 103 is 50 W, because Pmax_c1_in+Pmax_c2_in+Pmax_c3_in is 120 W, equal to Pmax_in (i.e., 120 W), the power configuration unit 201 configures the first power input port 101 to operate at Pmax_c1_in (i.e., 30 W), the second power input port 102 to operate at Pmax_c2_in (i.e., 40 W), and the third power input port 103 to operate at Pmax_c3_in (i.e., 50 W).

2. When the sum of the maximum allowable charging powers of the power input ports connected to external charging sources>Pmax_in, then the power configuration unit 201 configures those power input ports operate with a total power sum of Pmax_in, and:
(1) If only the first power input port 101 is connected to an external charging source, the power configuration unit 201 configures the first power input port 101 to operate at Pmax_in. For example, when the maximum allowable input power Pmax_in of the portable energy storage device is 120 W, and the maximum allowable charging power Pmax_c1_in of the first power input port 101 connected to an external charging source is 130 W, because Pmax_c1_in>Pmax_in, the power configuration unit 201 configures the first power input port 101 to operate at Pmax_in (i.e., 120 W).
(2) When the number of power input ports connected to external charging sources is N and the maximum allowable charging power of each power input port is greater than Pmax_in/N, then:

\textcircled{1} When N=2, that is, when the first power input port 101 and the second power input port 102 are connected to external charging sources, and the maximum allowable charging power of the first power input port 101 and the maximum allowable charging power of the second power input port 102 are both greater than Pmax_in/2, then the power configuration unit 201 configures both the first power input port 101 and the second power input port 102 to operate at Pmax_in/2.

For example, when the maximum allowable input power Pmax_in of the portable energy storage device is 120 W, the maximum allowable charging power Pmax_c1_in of the first power input port 101 is 70 W, and the maximum allowable charging power Pmax_c2_in of the second power input port 102 is 80 W, because Pmax_c1_in+Pmax_c2_in is 150 W, greater than Pmax_in (i.e., 120 W), the power configuration unit 201 configures both the first power input port 101 and the second power input port 102 to operate at Pmax_in/2 (i.e., 60 W).

\textcircled{2} When N=3, that is, when the first power input port 101, the second power input port 102, and the third power input port 103 are connected to external charging sources, and the maximum allowable charging power of the first power input port 101, the maximum allowable charging power of the second power input port 102, and the maximum allowable charging power of the third power input port 103 are all greater than Pmax_in/3, then the power configuration unit 201 configures the first power input port 101, the second power input port 102, and the third power input port 103 all to operate at Pmax_in/3.

For example, when the maximum allowable input power Pmax_in of the portable energy storage device is 120 W, the maximum allowable charging power Pmax_c1_in of the first power input port 101 is 70 W, the maximum allowable charging power Pmax_c2_in of the second power input port 102 is 80 W, and the maximum allowable charging power Pmax_c3_in of the third power input port 103 is 90 W, because Pmax_c1_in+Pmax_c2_in+Pmax_c3_in is 240 W, greater than Pmax_in (i.e., 120 W), the power configuration unit 201 configures the first power input port 101, the second power input port 102, and the third power input port 103 all to operate at Pmax_in/3 (i.e., 40 W).

(3) When the number of power input ports connected to external charging sources is N and the maximum allowable charging power of some power input ports is≤Pmax_in/N, then:

\textcircled{1} When N=2, that is, when the first power input port 101 and the second power input port 102 are connected to external charging sources, if the maximum allowable charging power of one of the power input ports is ≤Pmax_in/2, then for that power input port, the power configuration unit 201 performs the first power configuration, configuring that power input port to operate at its maximum allowable charging power. Assume the total power occupied by this power input port is B₁. The remaining power configurable by the power configuration unit 201 is P₁=Pmax_in−B₁. The number of power input ports remaining without allocated power is M₁=N−the number of power input ports configured to operate at maximum allowable charging power in the first configuration=2−1=1. For the remaining one power input port, since its maximum allowable charging power+B₁>Pmax_in, it is necessarily greater than Pmax_in−B₁ (i.e., necessarily greater than P₁), therefore its maximum allowable charging power is necessarily greater than P₁/M₁. Consequently, the power configuration unit 201 sets the remaining power input port to operate at P₁/M₁, i.e., P₁.

For example, when the maximum allowable input power Pmax_in of the portable energy storage device is 120 W, the maximum allowable charging power Pmax_c1_in of the first power input port 101 is 50 W, and the maximum allowable charging power Pmax_c2_in of the second power input port 102 is 80 W, because Pmax_c1_in+Pmax_c2_in is 130W, greater than Pmax_in (i.e., 120 W), the power configuration unit 201 configures the sum of the operating powers of the first power input port 101 and the second power input port 102 to be 120 W. Because the maximum allowable charging power of the first power input port 101 is 50 W, which is less than Pmax_in/2 (i.e., 60 W), therefore for this first power input port 101, the power configuration unit 201 performs the first power configuration, configuring the first power input port 101 to operate at its maximum allowable charging power Pmax_c1_in (i.e., 50 W). The total power occupied by this first power input port 101, B₁, is 50 W. The remaining power configurable by the power configuration unit 201 is P₁=Pmax_in−B₁=120 W−50 W=70 W. The number of power input ports remaining without allocated power is M₁=2−the number of power input ports configured to operate at maximum allowable charging power in the first configuration=2−1=1. Then for the remaining one power input port, i.e., the second power input port 102, because its maximum allowable charging power Pmax_c2_in is 80 W, greater than P₁/M₁ (i.e., 70 W), therefore the power configuration unit 201 configures the second power input port 102 to operate at 70 W.

\textcircled{2} When N=3, that is, when the first power input port 101, the second power input port 102, and the third power input port 103 are all connected to external charging source, if the maximum allowable charging power of two of the power input ports is ≤Pmax_in/3, then for those two power input ports, the power configuration unit 201 performs the first power configuration, configuring those two power input ports to operate at their maximum allowable charging powers. Assume the total power occupied by these two power input ports is B₁. The remaining power configurable by the power configuration unit 201 is P₁=Pmax_in−B₁. The number of power input ports remaining without allocated power is M₁=3−the number of power input ports configured to operate at maximum allowable charging power in the first configuration=3−2=1. Then for the remaining one power input port, since its maximum allowable charging power+B₁>Pmax_in, it is necessarily greater than Pmax_in−B₁ (i.e., necessarily greater than P₁), therefore its maximum allowable charging power is greater than P₁/M₁ (i.e., P₁). Consequently, the power configuration unit 201 sets the remaining power input port to operate at P₁/M₁ (i.e., P₁).

For example, when the maximum allowable input power Pmax_in of the portable energy storage device is 120 W, the maximum allowable charging power Pmax_c1_in of the first power input port 101 is 30 W, the maximum allowable charging power Pmax_c2_in of the second power input port 102 is 40 W, and the maximum allowable charging power Pmax_c3_in of the third power input port 103 is 60 W, because Pmax_c1_in+Pmax_c2_in+Pmax_c3_in is 130 W, greater than Pmax_in (i.e., 120 W), the power configuration unit 201 configures the sum of the operating powers of the first power input port 101, the second power input port 102, and the third power input port 103 to be 120 W. Because the maximum allowable charging powers of the first power input port 101 and the second power input port 102 are 30 W and 40 W respectively, falling within the range of ≤Pmax_in/3 (i.e., 40 W), therefore for these first power input port 101 and second power input port 102, the power configuration unit 201 performs the first power configuration, configuring the first power input port 101 and the second power input port 102 to operate at their maximum allowable charging powers Pmax_c1_in and Pmax_c2_in (i.e., 30 W and 40 W) respectively. The total power occupied by this first power input port 101 and second power input port 102, B₁, is 70 W. The remaining power configurable by the power configuration unit 201 is P₁=Pmax_in−B₁=120 W−70 W=50 W. The number of power input ports remaining without allocated power is M₁=3−the number of power input ports configured to operate at maximum allowable charging power in the first configuration=3−2=1. Then for the remaining one power input port, i.e., the third power input port 103, because its maximum allowable charging power Pmax_c3_in is 60 W, greater than P₁/M₁ (i.e., 50 W), therefore the power configuration unit 201 configures the third power input port 103 to operate at 50 W.

Furthermore, when N=3, that is, when the first power input port 101, the second power input port 102, and the third power input port 103 are all connected to external charging sources, if only one of the power input ports has a maximum allowable charging power ≤Pmax_in/3, then for that power input port, the power configuration unit 201 performs the first power configuration, configuring that power input port to operate at its maximum allowable charging power. Assume the total power occupied by this power input port is B₁. The remaining power configurable by the power configuration unit 201 is P₁=Pmax_in−B₁. The number of power input ports remaining without allocated power is M₁=3−the number of power input ports configured to operate at maximum allowable charging power in the first configuration =3−1=2. Then for the remaining two power input ports: If their maximum allowable charging powers are both greater than P₁/M₁, then the power configuration unit 201 sets both remaining power input ports to operate at P₁/M₁. If there exists one power input port among them whose maximum allowable charging power is ≤P₁/M₁, then the power configuration unit 201 performs the second power configuration, configuring that power input port to operate at its maximum allowable charging power. Assume the total power occupied by this power input port is B2. The remaining power configurable by the power configuration unit 201 is P₂=Pmax_in−B₁−B₂. The number of power input ports remaining without allocated power is M₂=M₁−the number of power input ports configured to operate at maximum allowable charging power in the second configuration=2−1=1. Since the maximum allowable charging power of this remaining power input port +B₁+B₂>Pmax_in, it is necessarily greater than Pmax_in−B₁−B₂ (i.e., necessarily greater than P₂), therefore its maximum allowable charging power is greater than P₂/M₂ (i.e., P₂). Consequently, the power configuration unit 201 sets the remaining power input port to operate at P₂/M₂ (i.e., P₂).

For example, when the maximum allowable input power Pmax_in of the portable energy storage device is 120 W, the maximum allowable charging power Pmax_c1_in of the first power input port 101 is 30 W, the maximum allowable charging power Pmax_c2_in of the second power input port 102 is 50 W, and the maximum allowable charging power of the third power input port 103 is 60 W, because Pmax_c1_in+Pmax_c2_in+Pmax_c3_in is 140 W, greater than Pmax_in (i.e., 120 W), the power configuration unit 201 configures the sum of the operating powers of the first power input port 101, the second power input port 102, and the third power input port 103 to be 120 W. Because only the maximum allowable charging power of the first power input port 101 is 30 W, less than Pmax_in/3 (i.e., 40 W), therefore the power configuration unit 201 performs the first power configuration, configuring this first power input port 101 to operate at its maximum allowable charging power Pmax_c1_in (i.e., 30 W). The total power occupied by this first power input port 101, B₁, is 30 W. The remaining power configurable by the power configuration unit 201 is P₁=Pmax_in−B₁=120 W−30 W=90 W. The number of power input ports remaining without allocated power is M₁=3—the number of power input ports configured to operate at maximum allowable charging power in the first configuration=3−1=2. Then for the remaining two power input ports, i.e., the second power input port 102 and the third power input port 103, because their maximum allowable charging powers Pmax_c2_in and Pmax_c3_in are 50 W and 60 W respectively, both greater than P₁/M₁=45 W, therefore the power configuration unit 201 configures both the second power input port 102 and the third power input port 103 to operate at P₁/M₁ (i.e., 45 W).

Another example, when the maximum allowable input power Pmax_in of the portable energy storage device is 120 W, the maximum allowable charging power Pmax_c1_in of the first power input port 101 is 30 W, the maximum allowable charging power Pmax_c2_in of the second power input port 102 is 45 W, and the maximum allowable charging power of the third power input port 103 is 60 W, because Pmax_c1_in+Pmax_c2_in+Pmax_c3_in is 135 W, greater than Pmax_in (i.e., 120 W), the power configuration unit 201 configures the sum of the operating powers of the first power input port 101, the second power input port 102, and the third power input port 103 to be 120 W. Because the maximum allowable charging power of the first power input port 101 is 30 W, less than Pmax_in/3 (i.e., 40 W), therefore for this first power input port 101, the power configuration unit 201 performs the first power configuration, configuring the first power input port 101 to operate at its maximum allowable charging power Pmax_c1_in (i.e., 30 W). The total power occupied by this first power input port 101, B₁, is 30 W. The remaining power configurable by the power configuration unit 201 is P₁=Pmax_in−B₁=120 W-30 W=90 W. The number of power input ports remaining without allocated power is M₁=3−the number of power input ports configured to operate at maximum allowable charging power in the first configuration=3−1=2. Then for the remaining two power input ports, i.e., the second power input port 102 and the third power input port 103, because the maximum allowable charging power Pmax_c2_in of the second power input port 102 is 45 W, falling within the range of ≤P1/M₁ (i.e., 45 W), therefore, the power configuration unit 201 performs the second power configuration, configuring the second power input port 102 to operate at its maximum allowable charging power Pmax_c2_in (i.e., 45 W). The total power occupied by this second power input port 102, B₂, is 45 W. The remaining power configurable by the power configuration unit 201 is P₂=Pmax_in−B₁−B₂=45 W. The number of power input ports remaining without allocated power M₂=M₁−the number of power input ports configured to operate at maximum allowable charging power in the second configuration =1. Since the maximum allowable charging power of the third power input port 103 is 60 W, greater than P₂/M₂ (i.e., P₂=45 W), therefore the power configuration unit 201 sets the remaining third power input port 103 to operate at 45 W.

II. As shown in FIG. 3, when the number of power input ports is 4:

Since the power allocation logic corresponding to when one, two, and three power input ports are connected to external charging sources has been elaborated in detail above, and to avoid redundancy, for the case where the number of power input ports is 4, only the power allocation logic corresponding to when all four power input ports are connected to external charging sources will be elaborated in detail below. Based on convenience of expression and ease of distinction, when all four power input ports are connected to external charging sources, these four power input ports are defined as the first power input port 101, the second power input port 102, the third power input port 103, and the fourth power input port 104, and their maximum allowable charging powers are defined as Pmax_c1_in, Pmax_c2_in, Pmax_c3_in, Pmax_c4_in respectively. When charging:
(1) If Pmax_c1_in+Pmax_c2_in+Pmax_c3_in+Pmax_c4_in≤Pmax_in, then the power configuration unit 201 configures the first power input port 101 to operate at Pmax_c1_in, the second power input port 102 to operate at Pmax_c2_in, the third power input port 103 to operate at Pmax_c3_in, and the fourth power input port 104 to operate at Pmax_c4_in. For example, when the maximum allowable input power Pmax_in of the portable energy storage device is 120 W, the maximum allowable charging power Pmax_c1_in of the first power input port 101 is 20 W, the maximum allowable charging power Pmax_c2_in of the second power input port 102 is 30 W, the maximum allowable charging power Pmax_c3_in of the third power input port 103 is 30 W, and the maximum allowable charging power Pmax_c4_in of the fourth power input port 104 is 40 W, because Pmax_c1_in+Pmax_c2_in+Pmax_c3_in+Pmax_c4_in is 120 W, equal to Pmax_in (i.e., 120 W), the power configuration unit 201 configures the first power input port 101 to operate at Pmax_c1_in (i.e., 20 W), the second power input port 102 to operate at Pmax_c2_in (i.e., 30 W), the third power input port 103 to operate at Pmax_c3_in (i.e., 30 W), and the fourth power input port 104 to operate at Pmax_c4_in (i.e., 40 W).
(2) If Pmax_c1_in+Pmax_c2_in+Pmax_c3_in+Pmax_c4_in>Pmax_in, then:
\textcircled{1} If the maximum allowable charging power of only one power input port is ≤Pmax_in/4, then for that power input port, the power configuration unit 201 performs the first power configuration, causing that port to operate at its maximum allowable charging power. Assume the total power occupied by this port is B₁. The remaining configurable power for the power configuration unit 201 is P₁=Pmax_in−B₁. The number of remaining power input ports without allocated power is M₁=4−Number of ports configured to run at max power in the first configuration=4−1=3.

For the remaining 3 power input ports: If all their maximum allowable charging powers are>P₁/M₁, then the power configuration unit 201 sets all three remaining ports to operate at P₁/M₁. If one of these 3 ports has a maximum allowable charging power≤P₁/M₁, then the power configuration unit 201 performs the second power configuration, causing that port to operate at its maximum allowable charging power. Assume the total power occupied by this port is B₂. The remaining configurable power is P₂=Pmax_in−B₁−B₂. The number of remaining ports without allocated power is M₂=M₁−Number of ports configured to run at max power in the second configuration=3−1=2.

For the remaining 2 power input ports: If all their maximum allowable charging powers are>P₂/M₂, then the power configuration unit 201 sets both remaining ports to operate at P₂/M₂. If one of these 2 ports has a maximum allowable charging power≤P₂/M₂, then the power configuration unit 201 performs the third power configuration, causing that port to operate at its maximum allowable charging power. Assume the total power occupied by this port is B₃. The remaining configurable power is P₃=Pmax_in−B₁−B₂−B3. The number of remaining ports without allocated power is M₃=M₂−Number of ports configured to run at max power in the third configuration=2−1=1.

For the remaining single power input port: Because its maximum allowable charging power+B₁+B₂+B₃>Pmax_in, it must be greater than Pmax_in−B₁−B₂−B₃ (i.e., necessarily greater than P₃). Therefore, its maximum allowable charging power is>P₃/M₃ (which is simply P₃, since M₃=1). Consequently, the power configuration unit 201 sets the remaining port to operate at P₃/M₃=P₃.

For example, when the maximum allowable input power Pmax_in of the portable energy storage device is 200 W, the maximum allowable charging power Pmax_c1_in of the first power input port 101 is 50 W, the maximum allowable charging power Pmax_c2_in of the second power input port 102 is 60 W, the maximum allowable charging power Pmax_c3_in of the third power input port 103 is 70 W, and the maximum allowable charging power Pmax_c4_in of the fourth power input port 104 is 80 W. Because Pmax_c1_in+Pmax_c2_in+Pmax_c3_in+Pmax_c4_in is 260 W, greater than Pmax_in (i.e., 200 W), the power configuration unit 201 configures the sum of the operating powers of the first power input port 101, the second power input port 102, the third power input port 103, and the fourth power input port 104 to be 200 W. Because the maximum allowable charging power of the first power input port 101 is 50 W, equal to Pmax_in/4 (i.e., 50 W), therefore for this first power input port 101, the power configuration unit 201 performs the first power configuration, configuring the first power input port 101 to operate at its maximum allowable charging power Pmax_c1_in (i.e., 50 W). The total power occupied by this first power input port 101, B₁, is 50 W. The remaining power configurable by the power configuration unit 201 is P₁=Pmax_in−B₁=200 W−50 W=150 W. The number of power input ports remaining without allocated power is M₁=4−the number of power input ports configured to operate at maximum allowable charging power in the first configuration=4−1=3.

Then for the remaining three power input ports, i.e., the second power input port 102, the third power input port 103, and the fourth power input port 104, because their maximum allowable charging powers Pmax_c2_in, Pmax_c3_in, Pmax_c4_in are 60 W, 70 W, and 80 W respectively, all greater than P₁/M₁ (i.e., 50 W), therefore the power configuration unit 201 configures the second power input port 102, the third power input port 103, and the fourth power input port 104 all to operate at P₁/M₁ (i.e., 50 W).

Another example, when the maximum allowable input power Pmax_in of the portable energy storage device is 200 W, the maximum allowable charging power Pmax_c1_in of the first power input port 101 is 20 W, the maximum allowable charging power Pmax_c2_in of the second power input port 102 is 50 W, the maximum allowable charging power Pmax_c3_in of the third power input port 103 is 70 W, and the maximum allowable charging power Pmax_c4_in of the fourth power input port 104 is 80W, because Pmax_c1_in+Pmax_c2_in+Pmax_c3_in+Pmax_c4_in is 220 W, greater than Pmax_in (i.e., 200 W), the power configuration unit 201 configures the sum of the operating powers of the first power input port 101, the second power input port 102, the third power input port 103, and the fourth power input port 104 to be 200 W. Because the maximum allowable charging power of the first power input port 101 is 20 W, less than Pmax_in/4 (i.e., 50 W), therefore for this first power input port 101, the power configuration unit 201 performs the first power configuration, configuring the first power input port 101 to operate at its maximum allowable charging power Pmax_c1_in (i.e., 20 W). The total power occupied by this first power input port 101, B₁, is 20 W. The remaining power configurable by the power configuration unit 201 is P₁=Pmax_in−B₁=200 W−20 W=180 W. The number of power input ports remaining without allocated power is M₁=4−the number of power input ports configured to operate at maximum allowable charging power in the first configuration=4−1=3.

Then for the remaining three power input ports, because the maximum allowable charging power Pmax_c2_in of the second power input port 102 is 50 W, less than P₁/M₁ (i.e., 60 W), therefore, the power configuration unit 201 performs the second power configuration, configuring the second power input port 102 to operate at its maximum allowable charging power Pmax_c2_in (i.e., 50 W). The total power occupied by this second power input port 102, B₂, is 50 W. The remaining power configurable by the power configuration unit 201 is P₂=Pmax_in−B₁−B₂=130 W. The number of power input ports remaining without allocated power is M₂=M₁−the number of power input ports configured to operate at maximum allowable charging power in the second configuration=2. Because the maximum allowable charging powers of the third power input port 103 and the fourth power input port 104 are 70 W and 80 W respectively, both greater than P₂/M₂ (i.e., 65 W), therefore the power configuration unit 201 sets the remaining third power input port 103 and fourth power input port 104 both to operate at 65 W.

Another example, when the maximum allowable input power Pmax_in of the portable energy storage device is 200 W, the maximum allowable charging power Pmax_c1_in of the first power input port 101 is 20 W, the maximum allowable charging power Pmax_c2_in of the second power input port 102 is 50 W, the maximum allowable charging power Pmax_c3_in of the third power input port 103 is 65 W, and the maximum allowable charging power Pmax_c4_in of the fourth power input port 104 is 85 W, because Pmax_c1_in+Pmax_c2_in+Pmax_c3_in +Pmax_c4_in is 220 W, greater than Pmax_in (i.e., 200 W), the power configuration unit 201 configures the sum of the operating powers of the first power input port 101, the second power input port 102, the third power input port 103, and the fourth power input port 104 to be 200 W. Because the maximum allowable charging power of the first power input port 101 is 20 W, less than Pmax_in/4 (i.e., 50 W), therefore for this first power input port 101, the power configuration unit 201 performs the first power configuration, configuring the first power input port 101 to operate at its maximum allowable charging power Pmax_c1_in (i.e., 20 W). The total power occupied by this first power input port 101, B₁, is 20 W. The remaining power configurable by the power configuration unit 201 is P₁=Pmax_in−B₁=200 W−20 W=180 W. The number of power input ports remaining without allocated power is M₁=4−the number of power input ports configured to operate at maximum allowable charging power in the first configuration=4−1=3.

Then for the remaining three power input ports, because the maximum allowable charging power Pmax_c2_in of the second power input port 102 is 50 W, less than P₁/M₁ (i.e., 60 W), therefore, the power configuration unit 201 performs the second power configuration, configuring the second power input port 102 to operate at its maximum allowable charging power Pmax_c2_in (i.e., 50 W). The total power occupied by this second power input port 102, B₂, is 50 W. The remaining power configurable by the power configuration unit 201 is P2=Pmax_in−B₁−B₂=130 W. The number of power input ports remaining without allocated power is M₂=M₁−the number of power input ports configured to operate at maximum allowable charging power in the second configuration=2.

Because the maximum allowable charging power Pmax_c3_in of the third power input port 103 is 65 W, equal to P₂/M₂ (i.e., 65 W), therefore, the power configuration unit 201 performs the third power configuration, configuring the third power input port 103 to operate at its maximum allowable charging power Pmax_c3_in (i.e., 65 W). The total power occupied by this third power input port 103, B₃, is 65 W. The remaining power configurable by the power configuration unit 201 is P₃=Pmax_in−B₁−B₂−B₃=65 W. The number of power input ports remaining without allocated power is M₃=M₂−the number of power input ports configured to operate at maximum allowable charging power in the third configuration=1. Because the maximum allowable charging power of the fourth power input port 104 is 85 W, greater than P₃/M₃ (i.e., 65 W), therefore the power configuration unit 201 sets the remaining fourth power input port 104 to operate at 65 W.

\textcircled{2} If two of the power input ports have maximum allowable charging powers≤Pmax_in/4, then for those two power input ports, the power configuration unit 201 performs the first power configuration, configuring those two power input ports to operate at their maximum allowable charging powers. Assume the total power occupied by these two power input ports is B₁. The remaining power configurable by the power configuration unit 201 is P₁=Pmax_in−B₁. The number of power input ports remaining without allocated power is M₁=4−the number of power input ports configured to operate at maximum allowable charging power in the first configuration=4−2=2. Then for the remaining two power input ports:

If their maximum allowable charging powers are both greater than P₁/M₁, then the power configuration unit 201 sets both remaining power input ports to operate at P₁/M₁.

If among these two power input ports, there still exists one power input port whose maximum allowable charging power is≤P₁/M₁, then the power configuration unit 201 performs the second power configuration, configuring that power input port to operate at its maximum allowable charging power. Assume the total power occupied by this power input port is B₂. The remaining power configurable by the power configuration unit 201 is P₂=Pmax_in−B₁−B₂. For the remaining one power input port, since its maximum allowable charging power +B₁+B₂>Pmax_in, it is necessarily greater than Pmax_in−B₁−B₂ (i.e., necessarily greater than P₂), therefore its maximum allowable charging power is greater than P₂/M₂. Consequently, the power configuration unit 201 sets the remaining power input port to operate at P₂/M₂=P₂.

For example, when the maximum allowable input power Pmax_in of the portable energy storage device is 200 W, the maximum allowable charging power Pmax_c1_in of the first power input port 101 is 20 W, the maximum allowable charging power Pmax_c2_in of the second power input port 102 is 30 W, the maximum allowable charging power Pmax_c3_in of the third power input port 103 is 70 W, and the maximum allowable charging power Pmax_c4_in of the fourth power input port 104 is 90 W, because Pmax_c1_in+Pmax_c2_in+Pmax_c3_in+Pmax_c4_in is 210 W, greater than Pmax_in (i.e., 200 W), the power configuration unit 201 configures the sum of the operating powers of the first power input port 101, the second power input port 102, the third power input port 103, and the fourth power input port 104 to be 200 W. Because the maximum allowable charging powers of the first power input port 101 and the second power input port 102 are 20 W and 30 W respectively, both less than Pmax_in/4 (i.e., 50 W), therefore for the first power input port 101 and the second power input port 102, the power configuration unit 201 performs the first power configuration, configuring the first power input port 101 and the second power input port 102 to operate at their maximum allowable charging powers Pmax_c1_in and Pmax_c2_in (i.e., 20 W and 30 W) respectively. The total power occupied by the first power input port 101 and the second power input port 102, B₁, is 50 W. The remaining power configurable by the power configuration unit 201 is P₁=Pmax_in−B₁=200 W−50 W=150 W. The number of power input ports remaining without allocated power is M₁=4−the number of power input ports configured to operate at maximum allowable charging power in the first configuration=4−2=2.

Then for the remaining two power input ports, because the maximum allowable charging power Pmax_c3_in of the third power input port 103 is 70 W, less than P₁/M₁ (i.e., 75 W), therefore, the power configuration unit 201 performs the second power configuration, configuring the third power input port 103 to operate at its maximum allowable charging power Pmax_c3_in (i.e., 70 W). The total power occupied by this third power input port 103, B₂, is 70 W. The remaining power configurable by the power configuration unit 201 is P₂=Pmax_in−B₁−B₂=80 W. The number of power input ports remaining without allocated power M₂=M₁−the number of power input ports configured to operate at maximum allowable charging power in the second configuration=1. Because the maximum allowable charging power of the fourth power input port 104 is 90 W, greater than P₂/M₂ (i.e., 80 W), therefore the power configuration unit 201 sets the remaining fourth power input port 104 to operate at 80 W.

\textcircled{3} If three of the power input ports have maximum allowable charging powers ≤Pmax_in/4, then for those three power input ports, the power configuration unit 201 performs the first power configuration, configuring those three power input ports to operate at their maximum allowable charging powers. Assume the total power occupied by these three power input ports is B₁. The remaining power configurable by the power configuration unit 201 is P₁=Pmax_in−B₁. The number of power input ports remaining without allocated power is M₁=4−the number of power input ports configured to operate at maximum allowable charging power in the first configuration=4−3=1. Then for the remaining one power input port, since its maximum allowable charging power is necessarily greater than P₁, therefore the power configuration unit 201 sets the remaining power input port to operate at P₁.

For example, when the maximum allowable input power Pmax_in of the portable energy storage device is 200 W, the maximum allowable charging power Pmax_c1_in of the first power input port 101 is 20 W, the maximum allowable charging power Pmax_c2_in of the second power input port 102 is 30 W, the maximum allowable charging power Pmax_c3_in of the third power input port 103 is 40 W, and the maximum allowable charging power Pmax_c4_in of the fourth power input port 104 is 120 W, because Pmax_c1_in+Pmax_c2_in+Pmax_c3_in+Pmax_c4_in is 210 W, greater than Pmax_in (i.e., 200 W), the power configuration unit 201 configures the sum of the operating powers of the first power input port 101, the second power input port 102, the third power input port 103, and the fourth power input port 104 to be 200 W. Because the maximum allowable charging powers of the first power input port 101, the second power input port 102, and the third power input port 103 are 20 W, 30 W, and 40 W respectively, all less than Pmax_in/4 (i.e., 50 W), therefore for these first power input port 101, second power input port 102, and third power input port 103, the power configuration unit 201 performs the first power configuration, configuring the first power input port 101, the second power input port 102, and the third power input port 103 to operate at their maximum allowable charging powers Pmax_c1_in, Pmax_c2_in, Pmax_c3_in (i.e., 20 W, 30 W, 40 W) respectively. The total power occupied by this first power input port 101, second power input port 102, and third power input port 103, B₁, is 90 W. The remaining power configurable by the power configuration unit 201 is P₁=Pmax_in−B₁=200 W−90 W=110 W. The number of power input ports remaining without allocated power is M₁=4−the number of power input ports configured to operate at maximum allowable charging power in the first configuration=4−3=1. Then for the remaining one power input port, i.e., the fourth power input port 104, because its maximum allowable charging power Pmax_c4_in is 120 W, greater than 110 W, therefore the power configuration unit 201 configures the fourth power input port 104 to operate at 110 W.

The above provides the power allocation rules for the portable energy storage device capable of simultaneous multi-port charging provided in this embodiment when the number of power input ports is three or four. Based on the examples for three and four ports, those skilled in the art can further deduce the relevant power allocation rules for five, six, or even more ports, which will not be repeated here.

The portable energy storage device capable of simultaneous multi-port charging provided in this embodiment has the following advantages: First, through the design of at least three power input ports, it can meet the demand for at least three external charging sources to simultaneously charge the portable energy storage device, greatly speeding up charging efficiency; Second, the implementation of the technical solution and its technical effects impose no restrictions on the types of power input ports, meaning that in practical applications, the power input ports can be various types of input ports, and the types can be the same or different from each other, thereby improving flexibility in practical application. For example, some or all power input ports can be bidirectional ports that can be used for both charging and discharging; Third, the power input ports can be used either individually or simultaneously. When used individually, by comparing the relationship between the energy storage device's maximum allowable input power and the port's maximum allowable charging power, the energy storage device can achieve maximum charging power input while ensuring safety; When multiple power input ports are used simultaneously, through the aforementioned power allocation logic, each power input channel is ensured to work in a balanced manner. This avoids the situation where one channel operates at high power while other channels operate at very low power or are idle, causing heat to concentrate in one location. Thereby, the safety of the portable energy storage device during charging is enhanced, and its service life is prolonged. Furthermore, this design also enables the multiple external charging sources that are connected and supplying power simultaneously to share the power load more evenly, thereby preventing these power sources from operating under full load conditions, thus greatly extending the service life of the external charging sources.

### Embodiment 3

This embodiment provides a charging power allocation method for a portable energy storage device, applied to the portable energy storage device capable of simultaneous multi-port charging described in Embodiment 1. As described in Embodiment 1, the portable energy storage device includes two power input ports and a power configuration unit 201, the power configuration unit 201 is configured to allocate charging power for power input ports connected to external charging sources.

Each power input port is preset with a maximum charging power, defining the smaller value between the preset maximum charging power of each port and the charging power that the external charging source can provide after being connected to that port as the maximum allowable charging power of that port; and defining the maximum allowable input power of the portable energy storage device as Pmax_in, the allocation method comprising:

When the sum of the maximum allowable charging power of the power input ports connected to external charging sources≤Pmax_in, the power configuration unit 201 configures those power input ports to each operate at their respective maximum allowable charging power.

When the sum of the maximum allowable charging power of the power input ports connected to external charging sources>Pmax_in, the power configuration unit 201 configures those power input ports to have a sum of operating power equal to Pmax_in, and configures power according to the following rules:

If the number of power input ports connected to external charging sources is 1, the power configuration unit 201 configures that power input port to operate at Pmax_in;

If the number of power input ports connected to external charging sources is 2, when the maximum allowable charging power of both power input ports is greater than half of Pmax_in, the power configuration unit 201 configures both power input ports to operate at Pmax_in/2; when the maximum allowable charging power of one of the power input ports≤half of Pmax_in, the power configuration unit 201 configures that power input port to operate at its maximum allowable charging power, and configures the other power input port to operate at (Pmax_in−the operating power of the power input port operating at its maximum allowable charging power).

### Embodiment 4

This embodiment provides a charging power allocation method for a portable energy storage device, applied to the portable energy storage device capable of simultaneous multi-port charging described in Embodiment 2. As described in Embodiment 2, the portable energy storage device includes at least three power input ports and a power configuration unit 201, the power configuration unit 201 is configured to allocate charging power for power input ports connected to external charging sources.

Each power input port is preset with a maximum charging power, defining the smaller value between the preset maximum charging power of each port and the charging power that the external charging source can provide after being connected to that port as the maximum allowable charging power of that port; defining the maximum allowable input power of the portable energy storage device as Pmax_in, the power allocation method comprising:

When the sum of the maximum allowable charging power of the power input ports connected to external charging sources≤Pmax_in, the power configuration unit 201 configures those power input ports to each operate at their respective maximum allowable charging power.

When the sum of the maximum allowable charging power of the power input ports connected to external charging sources>Pmax_in, the power configuration unit 201 configures those power input ports to have a sum of operating power equal to Pmax_in, and configures power according to the following rules:

If the number of power input ports connected to external charging sources is 1, the power configuration unit 201 configures that power input port to operate at Pmax_in;

If the number of power input ports connected to external charging sources is N, where N is a positive integer and ≥2, then:
when the maximum allowable charging power of each power input port is greater than Pmax_in/N, the power configuration unit 201 configures those power input ports to each operate at Pmax_in/N;
when among the N power input ports there exist some power input ports whose maximum allowable charging power≤Pmax_in/N, then for those power input ports, the power configuration unit 201 performs a first power allocation, causing those power input ports to operate at their maximum allowable charging power, assuming the total power occupied by those ports is B₁, the configurable remaining power of the power configuration unit is P₁=Pmax_in−B₁, and the number of power input ports remaining without allocated power is M₁=N−the number of ports allocated to operate at maximum allowable charging power in the first allocation, then for the remaining M₁ power input ports:
if their maximum allowable charging power is all greater than P₁/M₁, the power configuration unit 201 causes the remaining M₁ power input ports to each operate at P₁/M₁;
if there exist some power input ports whose maximum allowable charging power≤P₁/M₁, the power configuration unit 201 configures power according to the following rule, defining in said rule that after the power configuration unit 201 performs the k-th power allocation, the total power occupied by the ports allocated to operate at maximum allowable charging power in the k-th allocation is Bₖ, the configurable remaining power of the power configuration unit is Pₖ, the number of power input ports remaining without allocated power is Mₖ, k is a positive integer and≥1:
among the remaining Mₖ ports, for ports whose maximum allowable charging power≤Pₖ/Mₖ, the power configuration unit performs the (k+1)-th power configuration, setting those ports to operate at their maximum allowable charging power, assuming the total power occupied by these ports configured in the (k+1)-th step is Bₖ₊₁, the remaining power available for configuration is Pₖ₊₁=P_max_in−B₁− . . . −Bₖ₊₁, the number of remaining connected ports yet to have power allocated is Mₖ₊₁=Mₖ−(number of ports configured at max power in the (k+1)-th step); within this rule, when after the (k+1)-th power configuration, the maximum allowable charging powers of all the remaining Mₖ₊₁ ports are >Pₖ₊₁/Mₖ₊₁, this rule terminates, and the power configuration unit sets all remaining Mₖ₊₁ ports to operate at Pₖ₊₁/Mₖ₊₁.

It should be noted that in the present invention, the power allocated to a power input port is its operating power. For example, when it is mentioned that a power input port operates at 50 W, it means the power configuration unit configures 50 W of power to that power input port.

The specific embodiments of the present invention have been described above. Through the above description, relevant personnel can make various changes and modifications within the scope of the inventive idea of this invention.

1. A portable energy storage device capable of simultaneous multi-port charging, wherein
the device comprises a power configuration unit and two power input ports, the power configuration unit is configured to allocate charging power for power input ports connected to external charging sources; defining the maximum allowable input power of the energy storage device as Pmax_in;
when the number of power input ports connected to external charging sources is two, then:
a) when the sum of the maximum allowable charging power of the two power input ports≤Pmax_in, the power configuration unit configures both power input ports to operate at their respective maximum allowable charging power;
b) when the sum of the maximum allowable charging power of the two power input ports>Pmax_in, the power configuration unit configures the sum of the operating power of the two power input ports to be Pmax_in, and allocates power according to the following rules:
I) if the maximum allowable charging power of both power input ports is greater than Pmax_in/2, the power configuration unit configures both power input ports to operate at Pmax_in/2;
II) if the maximum allowable charging power of one of the power input ports ≤Pmax_in/2, the power configuration unit configures this power input port to operate at its maximum allowable charging power, and configures the other power input port to operate at the remaining power, the remaining power=(Pmax_in−the operating power of the power input port operating at its maximum allowable charging power).

2. A portable energy storage device capable of simultaneous multi-port charging, wherein
the device comprises a power configuration unit and at least three power input ports, the power configuration unit is configured to allocate the charging power for the power input ports that are connected to external charging sources, defining the maximum allowable input power of the energy storage device as Pmax_in;
when the number of power input ports connected to external charging sources is ≥2, defining this number as N, then:
if the sum of the maximum allowable charging powers of these connected ports >Pmax_in, the power configuration unit configures these ports to operate with a total power sum of Pmax_in, and allocates power according to the following rules:
a) when the maximum allowable charging power of each of these connected ports is >Pmax_in/N, the power configuration unit configures all these ports to operate at Pmax_in/N;
b) when among these connected ports, some ports have a maximum allowable charging power ≤Pmax_in/N, then for those specific ports, the power configuration unit performs the first power configuration, setting them to operate at their maximum allowable charging power, assuming the total power occupied by these ports configured in the first step is B₁, the remaining power available for configuration is P₁=Pmax_in−B₁, the number of remaining connected ports yet to have power allocated is M₁=N_31 (number of ports configured at max power in the first step), then for the remaining M₁ ports:
I) if their maximum allowable charging powers are all >P₁/M₁, the power configuration unit sets all remaining M₁ ports to operate at P₁/M₁;
II) if there are still some ports among the remaining M₁ ports with maximum allowable charging power ≤P₁/M₁, the power configuration unit configures power according to the following rule, defining within this rule that after the k-th power configuration where k is a positive integer and k≥1, the total power occupied by ports configured at their maximum allowable charging power in the k-th step is Bₖ, the remaining power available for configuration is Pₖ, and the number of remaining connected ports yet to have power allocated is Mₖ:
among the remaining Mₖ ports, for ports whose maximum allowable charging power ≤Pₖ/Mₖ, the power configuration unit performs the (k+1)-th power configuration, setting those ports to operate at their maximum allowable charging power, assuming the total power occupied by these ports configured in the (k+1)-th step is Bₖ₊₁, the remaining power available for configuration is Pₖ₊₁=P_max_in−B₁− . . . −Bₖ₊₁, the number of remaining connected ports yet to have power allocated is Mₖ₊₁=Mₖ−(number of ports configured at max power in the (k+1)-th step); within this rule, when after the (k+1)-th power configuration, the maximum allowable charging powers of all the remaining Mₖ₊₁ ports are >Pₖ₊₁/Mₖ₊₁, this rule terminates, and the power configuration unit sets all remaining Mₖ₊₁ ports to operate at Pₖ₊₁/Mₖ₊₁.

3. The portable energy storage device capable of simultaneous multi-port charging according to claim 2, wherein
when the number of power input ports connected to external charging sources ≥2, if the sum of the maximum allowable charging power of these connected ports ≤Pmax_in, the power configuration unit configures these connected ports to operate at their respective maximum allowable charging power.

4. The portable energy storage device capable of simultaneous multi-port charging according to claim 1, wherein
each power input port is predefined with a maximum charging power, and the maximum allowable charging power of a port is the smaller of the two values:
a) the port's predefined maximum charging power, and
b) the charging power that can be provided by the external charging source after it is connected to the port.

5. (canceled)

6. The portable energy storage device capable of simultaneous multi-port charging according to claim 1, wherein
some or all of power input ports are bidirectional ports that can be used for both charging and discharging.

7. The portable energy storage device capable of simultaneous multi-port charging according to claim 1, wherein
the interior of the portable energy storage device is provided with a main control board, and one or more independent circuit boards connected to the main control board, the power input ports are arranged on the circuit boards, and the power configuration unit is arranged on the main control board.

8. The portable energy storage device capable of simultaneous multi-port charging according to claim 7, wherein
the power configuration unit calculates the real-time power demand of each power input port by reading preset parameters of the power input ports and accordingly configures the charging power of each power input port, the preset parameters including current and voltage.

9. The portable energy storage device capable of simultaneous multi-port charging according to claim 7, wherein
both the printed circuit board and main control board are provided with protection circuits, the protection circuits including but not limited to any one or more of: overcurrent protection circuit, overvoltage protection circuit, overtemperature protection circuit, and short-circuit protection circuit (SCP);
wherein upon detection of abnormal conditions, the protection circuits respond by cutting off power to relevant circuits as necessary.

10. A method for allocating charging power in a portable energy storage device, wherein the method is applied to the portable energy storage device capable of simultaneous multi-port charging according to claim 1, and comprises:
when the number of power input ports connected to external charging sources is two, then:
a) when the sum of the maximum allowable charging power of the two power input ports ≤Pmax_in, the power configuration unit configures both power input ports to operate at their respective maximum allowable charging power;
b) when the sum of the maximum allowable charging power of the two power input ports >Pmax_in, the power configuration unit configures the sum of the operating power of the two power input ports to be Pmax_in, and allocates power according to the following rules:
I) if the maximum allowable charging power of both power input ports is greater than Pmax_in/2, the power configuration unit configures both power input ports to operate at Pmax_in/2;
II) if the maximum allowable charging power of one of the power input ports ≤Pmax_in/2, the power configuration unit configures this power input port to operate at its maximum allowable charging power, and configures the other power input port to operate at the remaining power, the remaining power=(Pmax_in−the operating power of the power input port operating at its maximum allowable charging power).

11. A method for allocating charging power in a portable energy storage device, wherein the method is applied to the portable energy storage device capable of simultaneous multi-port charging according to claim 2, and comprises:
when the number of power input ports connected to external charging sources is ≥2, defining this number as N, then:
if the sum of the maximum allowable charging powers of these connected ports >Pmax_in, the power configuration unit configures these ports to operate with a total power sum of Pmax_in, and allocates power according to the following rules:
a) when the maximum allowable charging power of each of these connected ports is >Pmax_in/N, the power configuration unit configures all these ports to operate at Pmax_in/N;
b) when among these connected ports, some ports have a maximum allowable charging power <Pmax_in/N, then for those specific ports, the power configuration unit performs the first power configuration, setting them to operate at their maximum allowable charging power, assuming the total power occupied by these ports configured in the first step is B₁, the remaining power available for configuration is P₁=Pmax_in−B₁, the number of remaining connected ports yet to have power allocated is M₁=N−(number of ports configured at max power in the first step), then for the remaining M₁ ports:
I) if their maximum allowable charging powers are all >P₁/M₁, the power configuration unit sets all remaining M₁ ports to operate at P₁/M₁;
II) if there are still some ports among the remaining M₁ ports with maximum allowable charging power ≤P₁/M₁, the power configuration unit configures power according to the following rule, defining within this rule that after the k-th power configuration where k is a positive integer and k≥1, the total power occupied by ports configured at their maximum allowable charging power in the k-th step is Bₖ, the remaining power available for configuration is Pₖ, and the number of remaining connected ports yet to have power allocated is Mₖ:
among the remaining Mₖ ports, for ports whose maximum allowable charging power ≤Pₖ/Mₖ, the power configuration unit performs the (k+1)-th power configuration, setting those ports to operate at their maximum allowable charging power, assuming the total power occupied by these ports configured in the (k+1)-th step is Bₖ₊₁, the remaining power available for configuration is Pₖ₊₁=P_max_in−B₁− . . . −Bₖ₊₁, the number of remaining connected ports yet to have power allocated is Mₖ₊₁=Mₖ−(number of ports configured at max power in the (k+1)-th step); within this rule, when after the (k+1)-th power configuration, the maximum allowable charging powers of all the remaining Mₖ₊₁ ports are>Pₖ₊₁/Mₖ₊₁, this rule terminates, and the power configuration unit sets all remaining Mₖ₊₁ ports to operate at Pₖ₊₁/Mₖ₊₁.

12. The portable energy storage device capable of simultaneous multi-port charging according to claim 2, wherein
each power input port is predefined with a maximum charging power, and the maximum allowable charging power of a port is the smaller of the two values:
a) the port's predefined maximum charging power, and
b) the charging power that can be provided by the external charging source after it is connected to the port.

13. (canceled)

14. The portable energy storage device capable of simultaneous multi-port charging according to claim 2, wherein
some or all of power input ports are bidirectional ports that can be used for both charging and discharging.

15. The portable energy storage device capable of simultaneous multi-port charging according to claim 2, wherein
the interior of the portable energy storage device is provided with a main control board, and one or more independent circuit boards connected to the main control board, the power input ports are arranged on the circuit boards, and the power configuration unit is arranged on the main control board.

16. The portable energy storage device capable of simultaneous multi-port charging according to claim 15, wherein
the power configuration unit calculates the real-time power demand of each power input port by reading preset parameters of the power input ports and accordingly configures the charging power of each power input port, the preset parameters including current and voltage.

17. The portable energy storage device capable of simultaneous multi-port charging according to claim 15, wherein
both the printed circuit board and main control board are provided with protection circuits, the protection circuits including but not limited to any one or more of: overcurrent protection circuit, overvoltage protection circuit, overtemperature protection circuit, and short-circuit protection circuit (SCP);
wherein upon detection of abnormal conditions, the protection circuits respond by cutting off power to relevant circuits as necessary.
